(19) United States
(12) Patent Application Publication
(10) Pub. No.: US 2014/0285681 A1
(43) Pub. Date: Sep. 25, 2014

(54) MULTI-VIEW IMAGING APPARATUS AND METHOD OF SENDING IMAGE DATA

(71) Applicant: KABUSHIKI KAISHA TOSHIBA, Tokyo (JP)

(72) Inventors: Kazuyo KANOU, Yokohama-Shi (JP); Katsuyuki KIMURA, Kamakura-Shi (JP); Yosuke BANDO, Yokohama-Shi (JP); Kojiro SUZUKI, Kawasaki-Shi (JP); Hideho ARAKIDA, Tokyo (JP); Fumihiko HYUGA, Kawasaki-Shi (JP); Kiwamu WATANABE, Kawasaki-Shi (JP); Hajime MATSUI, Yokohama-Shi (JP); Atsushi MOCHIZUKI, Kawasaki-Shi (JP); Sho KODAMA, Kawasaki-Shi (JP); Akira MORIYA, Kawasaki-Shi (JP)

(21) Appl. No.: 13/975,772

(22) Filed: Aug. 26, 2013

(30) Foreign Application Priority Data
Mar. 21, 2013 (JP) 2013-058765

(51) Int. Cl. H04N 5/225; H04N 5/76

(52) U.S. Cl. CPC H04N 5/2258; H04N 5/76
USPC 348/218.1

(57) ABSTRACT

A multi-view imaging apparatus of an embodiment includes a plurality of imaging units each including an image sensor and a memory configured to store therein image data taken by the image sensor, the imaging units being daisy-chain connected to each other in order to send the image data, and also includes an interface unit connected to a lowermost imaging unit, the interface unit being configured to output pieces of image data taken by the plurality of imaging units to an outside. The imaging units each add own-stage data to data outputted from an upper-stage imaging unit, and output the resultant data to a lower-stage imaging unit.

### CROSS-REFERENCE TO RELATED APPLICATIONS

This application is based upon and claims the benefit of priority from the prior Japanese Patent Application No. 2013-058765, filed on Mar. 21, 2013; the entire contents of which are incorporated herein by reference.

### FIELD

Embodiments described herein relate generally to a multi-view imaging apparatus and a method of sending image data.

### BACKGROUND

In conventional image sending systems, in order to send pieces of image data taken by a plurality of imaging units to an interface unit, the plurality of imaging units and the interface unit are daisy-chain connected to each other in some cases. In such cases, the number of the imaging units, the size (resolution) of the image data taken by each imaging unit, the transmission timing of the image data, and the like need to be set in advance to the interface unit and each imaging unit.

For this reason, in the case where information set in advance is incorrect, a problem that the image data is not correctly sent to the interface unit arises.

### BRIEF DESCRIPTION OF THE DRAWINGS

FIG. 1 is a schematic block diagram of a multi-view imaging apparatus according to a first embodiment of the present invention.

FIG. 2 is a schematic block diagram of an imaging unit in the multi-view imaging apparatus according to the first embodiment.

FIG. 3 is a diagram illustrating a format of image data obtained by each imaging unit.

FIG. 4 is a block diagram illustrating a schematic configuration of an imaging unit including a control signal receiver.

FIG. 5 is a block diagram illustrating a schematic configuration of an imaging unit including a control signal transmitter.

FIG. 6 is a diagram illustrating transmission data generated by each imaging unit according to the first embodiment.

FIG. 7 is a diagram illustrating transmission data generated by each imaging unit according to a modified example of the first embodiment.

FIG. 8 is a schematic block diagram of a multi-view imaging apparatus according to a second embodiment of the present invention.

FIG. 9 is a schematic block diagram of an imaging unit in the multi-view imaging apparatus according to the second embodiment.

FIG. 10 is a circuit diagram illustrating an example of a transmission possibility/impossibility determiner according to the second embodiment.

FIG. 11 is an example of a time chart illustrating data outputted by each imaging unit according to the second embodiment.

### DETAILED DESCRIPTION

A multi-view imaging apparatus of an embodiment includes: a plurality of imaging units each including an image sensor and a memory configured to store therein image data taken by the image sensor, the imaging units being daisy-chain connected to each other in order to send the image data; and an interface unit connected to a lowermost imaging unit, the interface unit being configured to output pieces of image data taken by the plurality of imaging units to an outside. The imaging units each add own-stage data to data outputted from an upper-stage imaging unit, and output the resultant data to a lower-stage imaging unit.

Embodiments will now be explained with reference to the accompanying drawings. It should be noted that, in each drawing, components having equivalent functions are denoted by the same reference signs, and detailed description of such components denoted by the same reference signs will not be repeated.

### First Embodiment

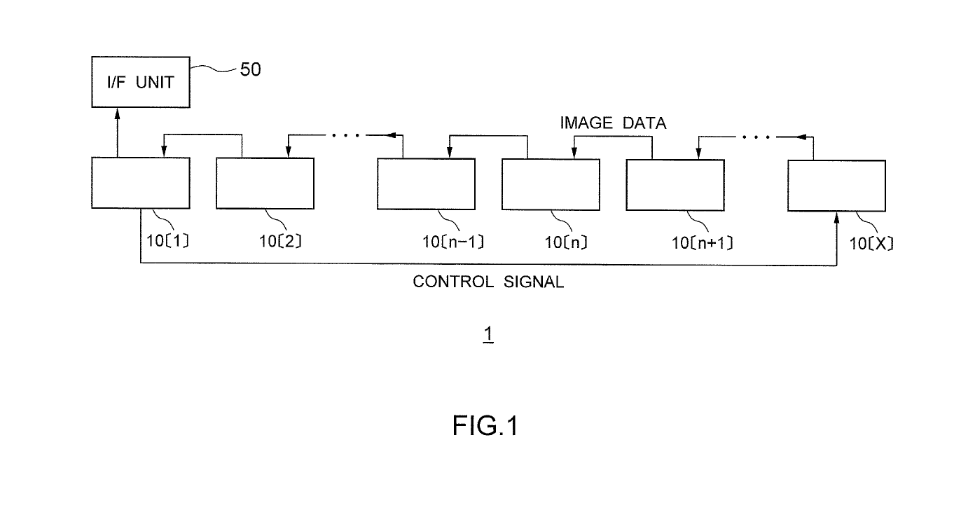

FIG. 1 illustrates a schematic block diagram of a multi-view imaging apparatus according to a first embodiment.

A multi-view imaging apparatus 1 according to the first embodiment includes: imaging units 10[1] to 10[X] (X: an integer equal to or more than 2); and an interface unit (I/F unit) 50 that is connected to the imaging unit 10[1] and outputs X pieces of image data taken by the imaging units 10[1] to 10[X] to the outside. The imaging units 10[1] to 10[X] are daisy-chain connected to each other. Further, the first imaging unit 10[1] and the last imaging unit 10[X] are connected to each other in order to transmit/receive a control signal.

In the multi-view imaging apparatus 1, the pieces of image data taken by the imaging units 10[1] to 10[X] are sent from the imaging unit 10[X] to the imaging unit 10[1] on a line basis, and are outputted to the interface unit 50. Because such line-based data is sequentially sent, X pieces of image data taken by the imaging units 10[1] to 10[X] are finally outputted to the interface unit 50.

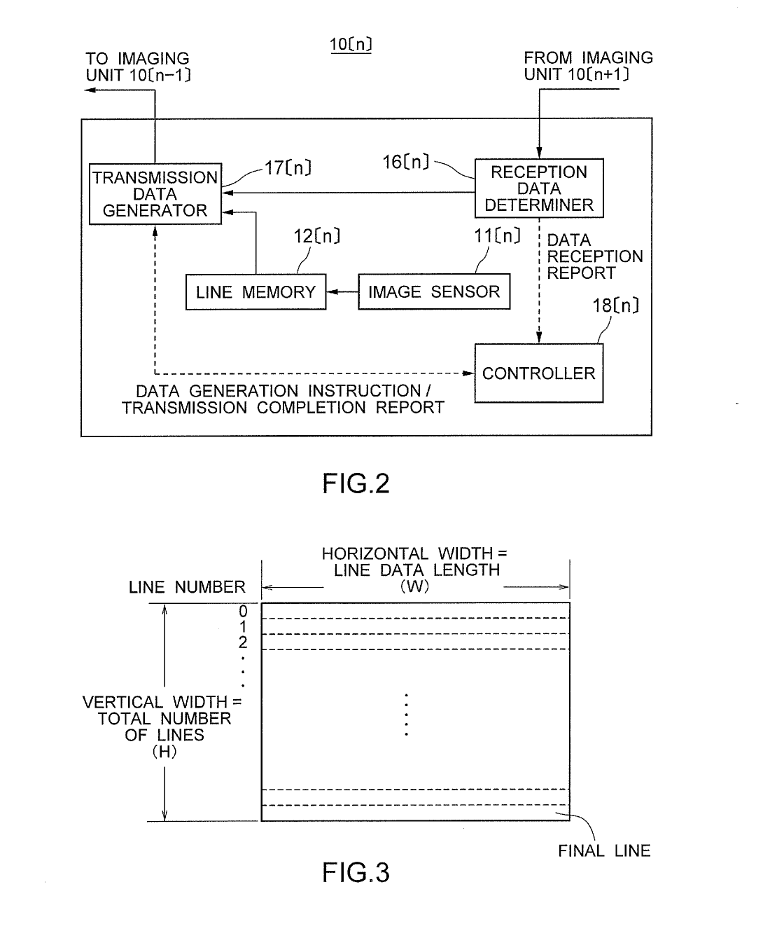

FIG. 2 is a schematic block diagram of an imaging unit 10[n]. The imaging unit 10[n] (n: an integer from 1 to X) includes an image sensor 11[n], a line memory 12[n], a reception data determiner 16[n], a transmission data generator 17[n], and a controller 18[n].

FIG. 3 illustrates a format of image data that is imaged by the image sensor 11 and is stored in the line memory 12. The line memory 12 stores therein the image data taken by the image sensor 11 on a line basis. Line numbers 0, 1, 2, . . . are respectively given to pieces of line data. It should be noted that, not limited to a line memory, the line memory 12 may be a different type of memory as long as the line memory 12 can store therein image data.

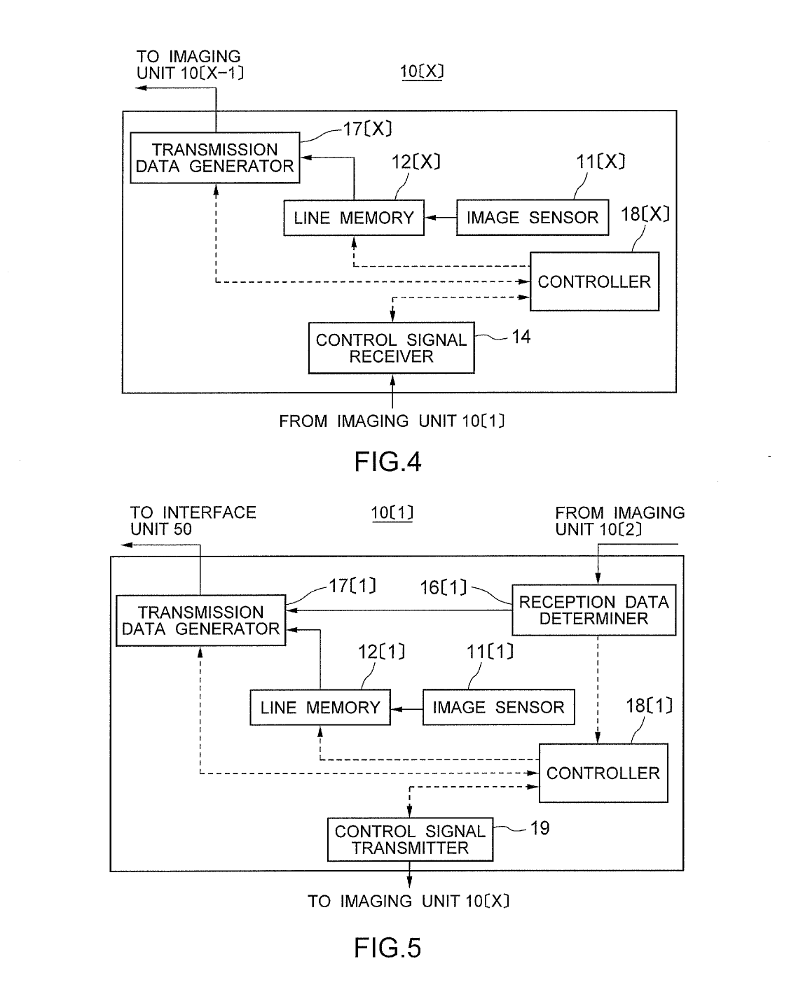

The imaging unit 10[X] further includes a control signal receiver 14, and the imaging unit 10[1] further includes a control signal transmitter 19. FIG. 4 is a block diagram of the imaging unit 10[X] including the control signal receiver 14, and FIG. 5 is a block diagram of the imaging unit 10[1] including the control signal transmitter 19. It should be noted that all the imaging units 10 may include the control signal receiver 14 and the control signal transmitter 19. If the imaging units 10 are thus configured in the same manner, the imaging units 10 can be combined without concern for first, intermediary, and last configurations, and expansion of the imaging units 10 can be facilitated.

The reception data determiner 16[n] receives (X−n)^{th} data outputted from the upper-stage imaging unit 10[n+1]. Further, the reception data determiner 16[n] performs a process of determining whether or not the reception data is valid. If determining that the reception data is valid, the reception data determiner 16[n] outputs a data reception report to the controller 18[n].

It should be noted that the reception data determiners 16[1] to 16[X−1] may each include a buffer (for example, a line buffer) that stores therein data outputted from the upper-stage imaging unit 10. With this configuration, for example, even in the case where data sending is retarded, a loss of received data can be prevented.

Upon reception of the data reception report from the reception data determiner 16[n], the controller 18[n] instructs the transmission data generator 17[n] to generate (X−n+1)^{th} data. Further, the controller 18[n] instructs the transmission data generator 17[n] to read out line data to be next transmitted (line data to which a desired number is given).

The transmission data generator 17[n] reads the line data to which a desired number is given, out of the line memory 12. The transmission data generator 17[n] adds the read-out line data to the (X−n)^{th} data, and thus generates the (X−n+1)^{th} data. Then, the transmission data generator 17[n] outputs the (X−n+1)^{th} data to the subsequent-stage imaging unit 10[n−1]. It should be noted that the transmission data generator 17[1] outputs X^{th} data to the interface unit 50. Further, upon completion of transmission of the (X−n+1)^{th} data, the transmission data generator 17[n] reports transmission completion to the controller 18[n].

It should be noted that there is no data reception of the transmission data generator 17[X] from the upper stage. The transmission data generator 17[X] reads the line data to which a desired number is given, out of the line memory 12, adds a header thereto, and thus generates first data. Then, the transmission data generator 17[X] outputs the first data to the subsequent-stage imaging unit 10[X−1]. The header contains information concerning the size of the image data, for example, a line data length (W) and a total number of lines (H).

Upon reception of the transmission completion report from the transmission data generator 17[1], the controller 18[1] reports the control signal transmitter 19 of the imaging unit 10[1] to that effect. Upon transmission of the X^{th} data to the interface unit 50, the control signal transmitter 19 transmits a control signal to the imaging unit 10[X]. The control signal receiver 14 of the imaging unit 10[X] receives, from the imaging unit 10[1], the control signal indicating that the imaging unit 10[1] is in a receivable state (in other words, the imaging unit 10[X] can transmit data). On the basis of this control signal, the controller 18[X] instructs the transmission data generator 17[X] to start transmission of the next line data.

Next, an operation of the multi-view imaging apparatus according to the first embodiment will be described. First, upon imaging by each of the image sensors 11[1] to 11[X] of the imaging units 10[1] to 10[X], the obtained image data is stored in each of the line memories 12[1] to 12[X]. The last imaging unit 10[X] adds a header containing information (W, H) concerning the size of the image data to line data with a line number 0 in the image data, thus generates first data, and outputs the first data to the imaging unit 10[X−1].

Next, the imaging unit 10[X−1] receives the first data, and the reception data determiner 16[X−1] determines whether or not this data is valid. If determining that this data is valid, the reception data determiner 16[X−1] outputs a data reception report to the controller 18[X−1]. Upon reception of the data reception report, the controller 18[X−1] instructs the transmission data generator 17[X−1] to generate second data. The transmission data generator 17[X−1] adds its own-stage line data with a line number 0, to the received first data, and thus generates the second data. The transmission data generator 17[X−1] outputs the second data to the imaging unit 10[X−2].

In this way, each imaging unit 10 sequentially transfers data obtained by adding its own-stage image data (line data) to received data. Finally, the imaging unit 10[1] transmits the X^{th} data containing pieces of line data with a line number 0 of all the imaging units, to the interface unit 50.

Upon transmission of the X^{th} data, the imaging unit 10[1] transmits a control signal reporting completion of data transmission corresponding to one line from each imaging unit 10, to the imaging unit 10[X]. Upon reception of this control signal, the imaging unit 10[X] outputs line data with a line number 1 to the imaging unit 10[X−1].

Such data transfer as described above is repeated until the final line, whereby all pieces of image data taken by each imaging unit 10 are transmitted to the interface unit 50.

In the multi-view imaging apparatus 1 of the present invention, image data transfer is performed while image data taken by the imaging unit at each stage is sequentially added to image data taken by the imaging unit 10[X], and hence the number of imaging units does not need to be set in advance. Further, the size of image data is contained in a header, and hence the size of image data also does not need to be set in advance. In addition, a transmission process at each stage is started upon data reception as the trigger, and hence transmission timing also does not need to be set in advance.

Accordingly, the first embodiment can provide a multi-view imaging apparatus that can autonomously send image data without making settings in advance. Further, because the need to make settings in advance is eliminated, even the case where the number of imaging units or resolution is changed can be easily dealt with.

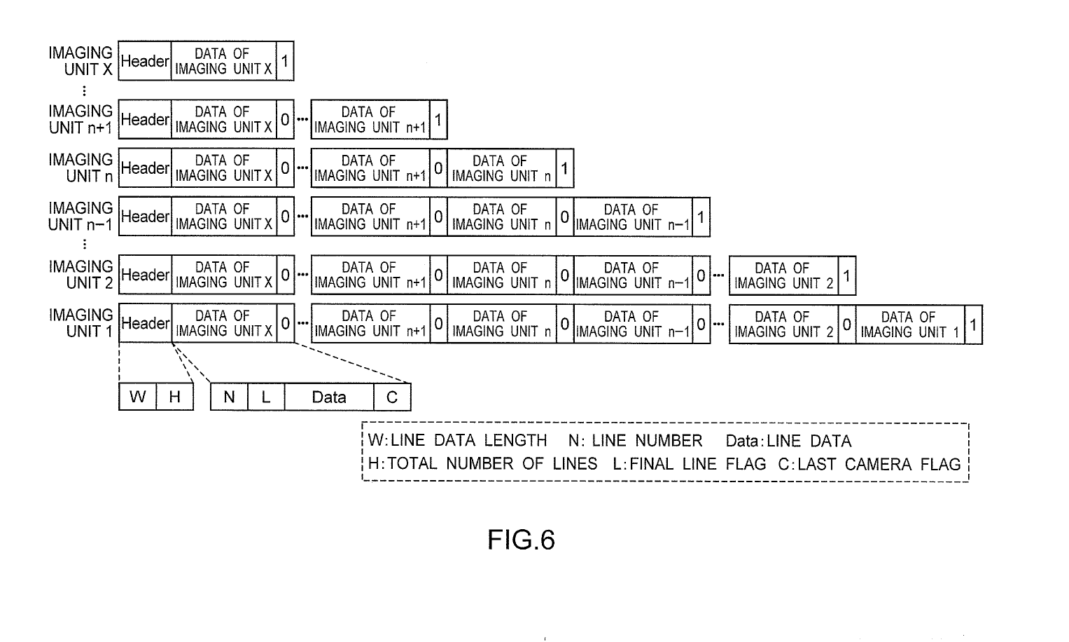

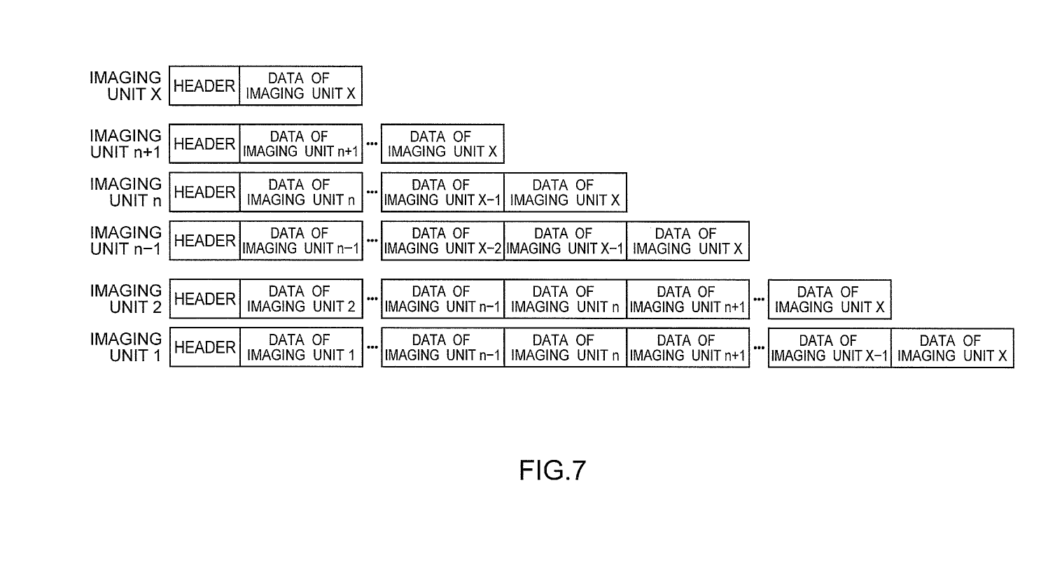

Next, a generation example of transmission data in the transmission data generator will be described. FIG. 6 illustrates the case where own-stage data is added to after reception data, and FIG. 7 illustrates the case where own-stage data is added to after the header of reception data.

In the case as illustrated in FIG. 6 where own-stage data is added to after received data, a last flag (last camera flag C) is used. This last flag indicates the tail end of the received data

In a determination process, the reception data determiner 16[i] (i: an integer from 1 to X−1) checks whether or not a set last flag is at the tail end of (X−1)^{th} data. If the set last flag is thereat, the reception data determiner 16[i] determines that the data is valid.

Then, when generating (X−i+1)^{th} data, the transmission data generator 17[i] clears the last flag in the (X−i)^{th} data, and adds line data having a tail end to which a last flag is set, to after the (X−i)^{th} data.

That is, the imaging unit 10[i] detects the last flag at the tail end of the data received from the imaging unit 10[i+1], and changes the last flag from “1” to “0”. Moreover, the imaging unit 10[i] sets “1” to the last flag at the tail end of its own-stage line data, and transmits the resultant data.

In a scheme illustrated in FIG. 6, for received data, the last of this data is determined by the last flag at the tail end thereof. For data to be transmitted, own-stage line data having a tail end to which a last flag is set is added to after received data, and the resultant data is transmitted.

In the case of FIG. 7, in a determination process, the reception data determiner 16[i] (i: an integer from 1 to X−1) checks the header of the (X−i)^{th} data. If contents of the header can be checked, the reception data determiner 16[i] determines that the data is valid.

Then, when generating the (X−i+1)^{th} data, the transmission data generator 17[i] adds line data with a desired line number to after the header of the (X−i)^{th} data.

In the case of a scheme illustrated in FIG. 7, generation of transmission data can be started before reception of all pieces of data, and hence a process of sending image data can be sped up. That is, if determining in the determination process that the data is valid, the reception data determiner 16[i] outputs, as the (X−i+1)^{th} data, the header of the (X−i)^{th} data, its own-stage line data, and sequentially received pieces of the (X−i)^{th} data in the stated order, to the imaging unit 10[i−1] or the interface unit 50.

In the meantime, in the case where line data with a line number to be transmitted is missing due to a trouble in the image sensor, a difference in image sensor resolution between the imaging units 10, and the like, a position in the image, of line data added at its own stage are displaced from those of other imaging units in some cases. In order to smoothly send image data even in such cases, transmission data may contain a line number (N) and a final line flag (L). That is, the transmission data generator 17[i] (i: an integer from 1 to X) may add, to the line data added to the (X−i)^{th} data, the line number (N) of this line data and the final line flag (L) indicating whether or not this line data is in the final line.

In the case where line data to be transmitted is missing, the transmission data generator 17[i] uses, for example, dummy data or line data with the next line number. Consequently, image data can be smoothly sent.

In the case where the sizes of pieces of image data taken by the imaging units 10 are different from one another, an imaging unit having low resolution may receive data from the upper-stage imaging unit even after the end of sending of all pieces of its own image data. The transmission data generator 17 of the imaging unit that has already sent all pieces of line data adds dummy data to which the final line flag (L) is set, and transmits the resultant data. Consequently, image data can be smoothly sent. It should be noted that the interface unit 50 performs a process of ignoring or deleting the dummy data, that is, the line data of second and subsequent times to which the final line flag (L) is set.

Further, in the case where the sizes of pieces of image data taken by the imaging units 10 are the same as one another, the last imaging unit 10[X] adds the line number (N), and the other imaging units may not add the line number (N). In this case, the transmission data generator 17[X] stores the line number of line data transmitted to the imaging unit 10[X−1], in the header of the first data. Meanwhile, the transmission data generator 17[i] (i: an integer from 1 to X−1) adds line data corresponding to the line number stored in the header of the first data, to the (X−i)^{th} data.

Further, the present embodiment can deal with even the case where the sizes of pieces of image data taken by the imaging units 10 are different from one another. In this case, similarly to the imaging unit 10[X], the imaging unit 10[i] (i: an integer from 1 to X−1) adds a header containing information concerning the size of its own-stage image data, to its own-stage line data. Consequently, for example, even in the case where horizontal image resolution is different for each imaging unit 10, each imaging unit 10 sends line data having a different length, whereby image sending can be achieved without making settings in advance. That is, the horizontal resolution and/or the vertical resolution of an image taken by the imaging unit can be freely set. The present scheme is advantageous in, for example, the case where, in a multi-view imaging apparatus including imaging units arranged in a grid-like pattern, high-resolution image sensors are placed in a central region thereof, and low-resolution image sensors are placed in a peripheral region thereof.

### Second Embodiment

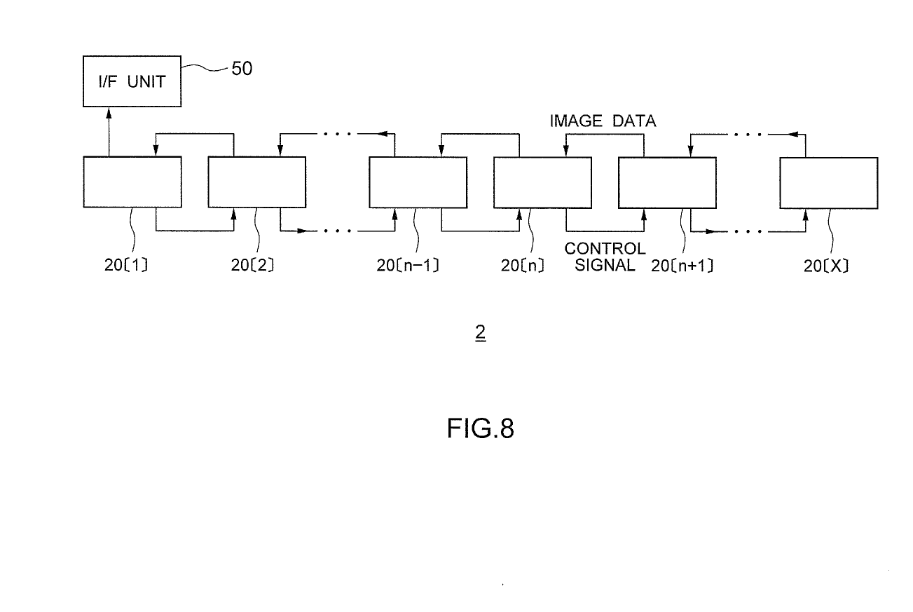

FIG. 8 is a schematic block diagram of a multi-view imaging apparatus according to a second embodiment. A multi-view imaging apparatus 2 according to the second embodiment includes: imaging units 20[1] to 20[X] (X: an integer equal to or more than 2); and an interface unit 50 that is connected to the imaging unit 20[1] and outputs X pieces of image data taken by the imaging units 20[1] to 20[X] to the outside. The imaging units 20[1] to 20[X] are daisy-chain connected to each other. Further, adjacent imaging units 20[n] (n: an integer from 1 to X−1) and 20[n+1] are connected to each other in order to transmit/receive a control signal. In the case where its own stage of the imaging unit 20[n] is in a receivable state, the imaging unit 20[n] transmits a control signal to that effect to the imaging unit 20[n+1].

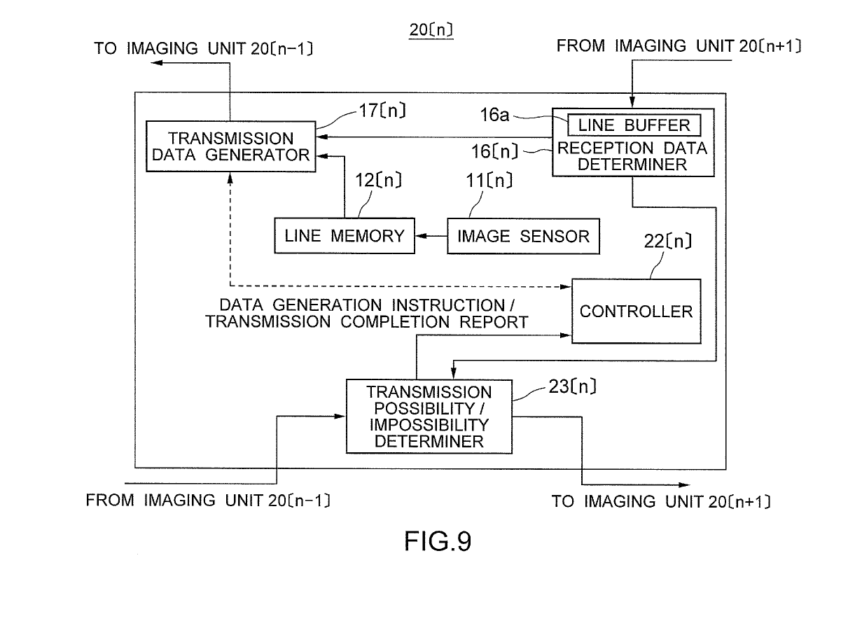

Hereinafter, detailed description of components described in the first embodiment will be omitted, and only differences from the first embodiment will be described. FIG. 9 is a schematic block diagram of the imaging unit 20[n]. The imaging unit 20[n] includes an image sensor 11[n], a line memory 12[n], a reception data determiner 16[n], a transmission data generator 17[n], a controller 22[n], and a transmission possibility/impossibility determiner 23[n]. It should be noted that there is no line data reception of the uppermost-stage imaging unit 20[X] from another imaging unit, and hence the uppermost-stage imaging unit 20[X] may not include a reception data determiner 16[X].

In the multi-view imaging apparatus 2, pieces of image data taken by the image sensors 11[1] to 11[X] are sent from the imaging unit 20[X] to the imaging unit 20[1] on a line basis.

The reception data determiner 16[n] includes a line buffer 16a, and stores, in the line buffer 16a, (X−n)^{th} data received from the upper-stage imaging unit 20[n+1]. It should be noted that, not limited to a line buffer, the line buffer 16a may be a different buffer.

Upon completion of transmission of (X−n+1)^{th} data, the transmission data generator 17[n] reports transmission completion to the controller 22[n].

The transmission possibility/impossibility determiners 23[2] to 23[X] each determine a transmittable state on the basis of a control signal received from the imaging unit 20[n−1] and a data reception report from the reception data determiner 16[n]. Further, upon transmission of the (X−n+1)^{th} data to the imaging unit 20[n−1], the transmission possibility/impossibility determiner 23[n] transmits a control signal indicating that its own stage is in a receivable state, to the imaging unit 20[n+1]. Upon transmission of X^{th} data to the interface unit 50, the transmission possibility/impossibility determiner 23[1] transmits a control signal indicating that its own stage is in a receivable state, to the imaging unit 20[2].

If the transmission possibility/impossibility determiner 23[n] determines a transmittable state, the controller 22[n] instructs the transmission data generator 17[n] to generate the (X−n+1)^{th} data. Further, the controller 22[n] instructs the transmission data generator 17[n] to read out line data to be next transmitted (line data to which a desired number is given).

Next, an operation of the multi-view imaging apparatus according to the second embodiment will be described. First, upon imaging by each of the image sensors 11[1] to 11[X] of the imaging units 20[1] to 20[X], the obtained image data is stored in each of the line memories 12[1] to 12[X]. The last imaging unit 20[X] adds a header containing information (W, H) concerning the size of the image data to line data with a line number 0 in the image data, thus generates first data, and outputs the first data to the imaging unit 20[X−1].

Next, the imaging unit 20[X−1] receives the first data, and the reception data determiner 16[X−1] determines whether or not this data is valid. If determining that this data is valid, the imaging unit 20[X−1] adds line data with a line number 0 in the image data to the first data, thus generates second data, and outputs the second data to the imaging unit 20[X−2], on the basis of a control signal received from the imaging unit 20[X−2]. Upon completion of the data transmission, the imaging unit 20[X−1] transmits a control signal indicating that the imaging unit 20[X−1] is in a receivable state, to the imaging unit 20[X].

In this way, each imaging unit sequentially transfers data obtained by adding its own-stage image data (line data) to received data. Finally, the imaging unit 20[1] transmits the X^{th} data containing pieces of line data with a line number 0 of all the imaging units, to the interface unit 50.

It should be noted that the same operation is performed in second and subsequent rounds (sending of pieces of line data with line numbers equal to and more than 1). That is, upon reception of a control signal indicating that the imaging unit 20[n−1] (n is an integer that is equal to or more than 2 and equal to or less than X) is in a receivable state, the imaging unit 20[n] adds line data with the corresponding line number, thus generates the (X−n+1)^{th} data, and outputs the generated data to the imaging unit 20[n−1]. Upon completion of the data transmission, the imaging unit 20[n] transmits a control signal to the imaging unit 20[n+1].

Such data transfer as described above is repeated until the final line, whereby all pieces of image data taken by each imaging unit 20 are transmitted to the interface unit 50.

As has been described above, in the multi-view imaging apparatus according to the second embodiment, similarly to the first embodiment, the number of imaging units, the size of image data, the transmission timing of image data, and the like do not need to be set in advance. Accordingly, the second embodiment can provide a multi-view imaging apparatus that can autonomously send image data without making settings in advance.

Moreover, in the second embodiment, transmission is performed at each stage on the basis of a control signal received from the lower-stage imaging unit, without waiting for the imaging unit 20[1] to transmit data to the interface unit 50. Hence, data sending speed can be increased.

It should be noted that, on the basis of states of all the imaging units from its own stage to the imaging unit 20[1], the transmission possibility/impossibility determiners 23[2] to 23[X−1] may determine whether or not data can be transmitted. This makes transmission possibility/impossibility determination more accurate, so that image data can be more smoothly sent.

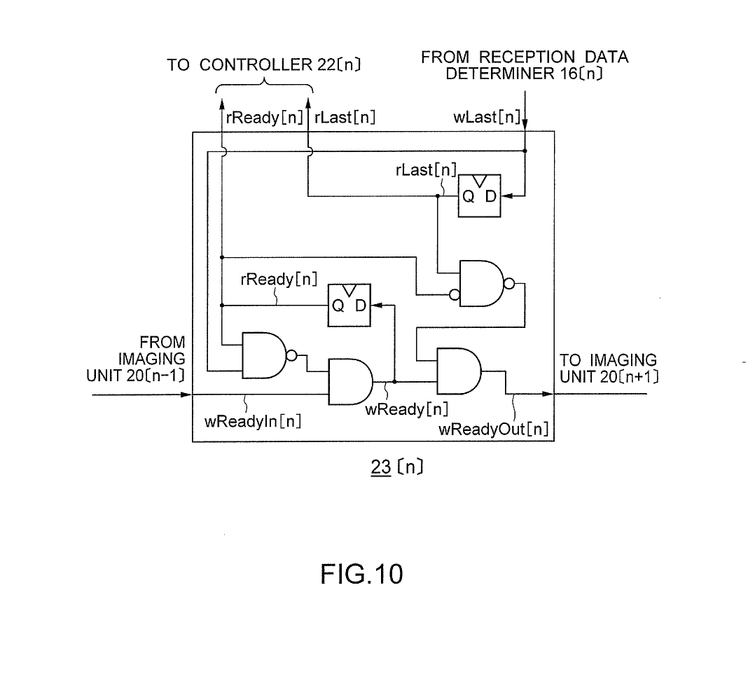

FIG. 10 is an example of a circuit diagram of the transmission possibility/impossibility determiner 23[n] (n: an integer from 2 to X−1). In FIG. 10, a prefix “w” in each signal name denotes a combinational circuit signal that does not pass through a flip-flop, and a prefix “r” in each signal name denotes a signal that passes through a flip-flop.

The transmission possibility/impossibility determiner 23[n] receives a control signal wReadyIn[n] (=wReadyOut[n−1]) from the lower-stage imaging unit 20[n−1], and transmits a control signal wReadyOut[n] (=wReadyIn[n+1]) to the upper-stage imaging unit 20[n+1].

Upon reception, from the reception data determiner 16[n], of a signal wLast[n] indicating whether or not a determination process (for example, a process of checking the last flag C) is completed, the transmission possibility/impossibility determiner 23[n] transmits a signal rReady[n] and a signal rLast[n] to the controller 22[n].

The circuit illustrated in FIG. 10 outputs a wReady[n] signal on the basis of the following logical expression (1).

wReady[n]=wReady[n−1] & !(rLast[n−1] & !rReady[n−1]) & !(wLast[n] & rReady[n]) (1)

Here, part of the terms in the right-hand side of Expression (1) corresponds to an output of the transmission possibility/impossibility determiner 23[n−1], and hence Expression (1) can be transformed in the following manner.

$$\begin{matrix}wReady ( n ) = wReadyOut [ n - 1 ] \& ! ( wLast [ n ] \& rReady [ n ] ) \\ = wReadyIn [ n ] \& ! ( wLast [ n ] \& rReady [ n ] )\end{matrix} \qquad ( 2 )$$

wReadyIn[n] in Expression (2) becomes active while a control signal is received from the lower-stage imaging unit. !(wLast[n] & rReady[n]) in Expression (2) becomes active while a determination process is not performed by the lower-stage imaging unit.

It should be noted that wReady[n−1] in Expression (1) is a signal that propagates over a plurality of imaging units, and thus may be a critical path. Meanwhile, it is sufficient for a wReady signal to propagate to the imaging unit 20[X] until transfer of data corresponding to one transaction is completed, and hence the wReady signal can be a path for a plurality of cycles. Accordingly, an embodiment in which a flip-flop is disposed in the course of the wReady signal path can be assumed.

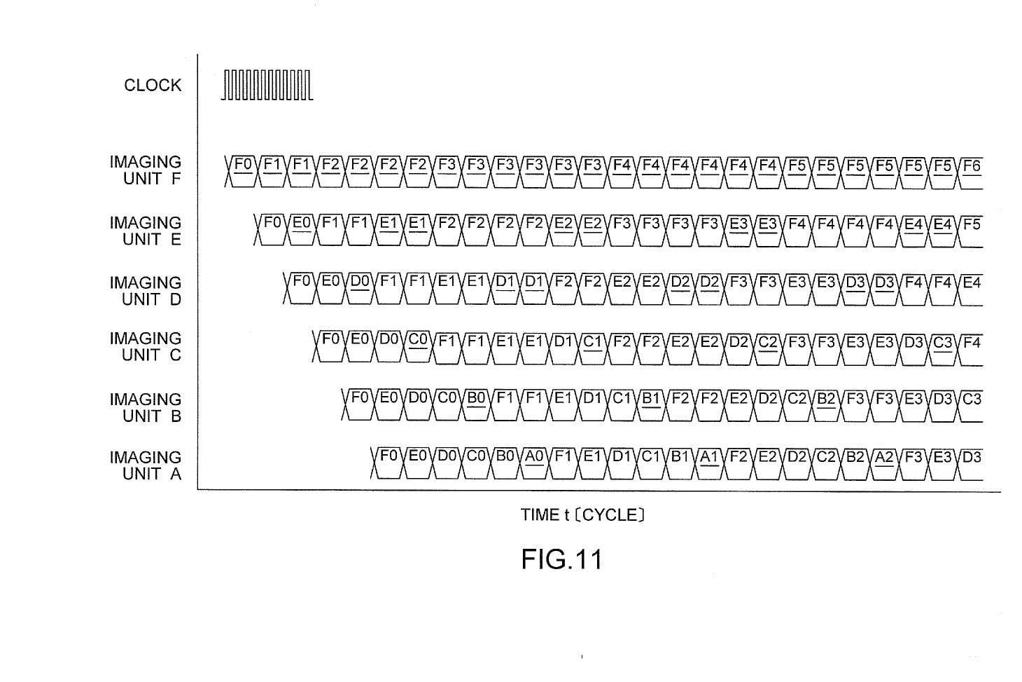

FIG. 11 is an example of a time chart illustrating data outputted by each imaging unit according to the second embodiment. In this example, the number of imaging units is six (A to F). In FIG. 11, ‘F0’ means data with a line number 0 sent out from the imaging unit F. Generally speaking, ‘Xn’ means data with a line number n sent out from an imaging unit X (=A to F). Further, each piece of underlined data in FIG. 11 indicates data to which the last flag C is given.

In FIG. 11, after transmission of F0, the last imaging unit F outputs F1 twice, F2 four times, and F3 and pieces of data with subsequent line numbers six times. Outputs from the imaging unit A are F0-E0-D0-C0-B0-A0-F1-E1- . . . , and hence the outputs are correctly obtained. In this way, even if each imaging unit does not have such information as the number of imaging units (image sensors) in the multi-view imaging apparatus and the order of data transfer, data is outputted in a cycle corresponding to the number of imaging units.

It should be noted that, in FIG. 11, a plurality of clocks are required for data sending, but the number of clocks required for data sending can change depending on the performance of a sending channel.

Further, in FIG. 11, the same data is transmitted a plurality of times until a transmittable state is determined, but data may be actually transmitted only last one time when a transmittable state is determined.

Hereinabove, the first and second embodiments have been described. In the above description, the imaging units included in the multi-view imaging apparatus are categorized into three types of the first imaging unit, the intermediary imaging unit(s), and the last imaging unit, but a multi-view imaging apparatus including imaging units all having the same configuration can also be assumed. In this case, each imaging unit determines its own position by means of connection of a control line for control signal exchange, and performs an operation suited to its own position. In the case of the first embodiment, for example, if a given imaging unit is connected to the interface unit, the given imaging unit is recognized as the first imaging unit. On the other hand, if a given imaging unit is not connected to the interface unit but connected to a control line, the given imaging unit is recognized as the last imaging unit. If neither applies, the given imaging unit is recognized as the intermediary imaging unit. In the case of the second embodiment, for example, if a given imaging unit is connected to the interface unit, the given imaging unit is recognized as the first imaging unit. On the other hand, if only the receiving side of a control line is connected to a given imaging unit, the given imaging unit is recognized as the last imaging unit. If neither applies, the given imaging unit is recognized as the intermediary imaging unit. If all the imaging units are thus configured in the same manner, the manufacturability and expandability of the multi-view imaging apparatus can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A multi-view imaging apparatus comprising:
a plurality of imaging units each comprising an image sensor and a memory configured to store therein image data taken by the image sensor, the imaging units being daisy-chain connected to each other in order to send the image data; and
an interface unit connected to a lowermost imaging unit, the interface unit being configured to output pieces of image data taken by the plurality of imaging units to an outside,
the imaging units being each configured to add own-stage data to data outputted from an upper-stage imaging unit and output the resultant data to a lower-stage imaging unit.

2. A multi-view imaging apparatus comprising:
a first imaging unit;
a second imaging unit;
at least one third imaging unit series-connected between the first imaging unit and the second imaging unit; and
an interface unit connected to the first imaging unit, and configured to output pieces of image data taken by the first to third imaging units to an outside,
the first to third imaging units each comprising: an image sensor; and a memory configured to store therein image data taken by the image sensor, the first to third imaging units being daisy-chain connected to each other in order to send the image data on a line basis, and configured to add own-stage data to data outputted from an upper-stage imaging unit and output the resultant data to a lower-stage imaging unit.

3. The multi-view imaging apparatus of claim 2, wherein
the first imaging unit transmits a control signal to the second imaging unit, upon completion of transmission of the data to the interface unit, and
the second imaging unit starts transmission of next line data of the data, upon reception of the control signal.

4. The multi-view imaging apparatus of claim 2, wherein
the first or third imaging unit further comprises:
a reception data determiner configured to receive the data outputted from the upper-stage imaging unit, determine whether or not the received data is valid, and output a data reception report if determining that the received data is valid;
a transmission data generator configured to add line data in the image data stored in the memory, to the received data, to generate transmission data, and output the transmission data to the lower-stage imaging unit; and
a controller configured to instruct the transmission data generator to generate the transmission data, upon reception of the data reception report from the reception data determiner.

5. The multi-view imaging apparatus of claim 4, wherein
the first imaging unit further comprises a control signal transmitter configured to transmit a control signal indicating that data is transmittable, to the second imaging unit,
the second imaging unit further comprises a control signal receiver configured to receive the control signal,
the control signal transmitter transmits the control signal to the control signal receiver, upon transmission of the data to the interface unit by the first imaging unit, and
the second imaging unit transmits next line data of the data, upon reception of the control signal.

6. The multi-view imaging apparatus of claim 4, wherein
the second imaging unit adds a last flag to own-stage line data, and transmits the resultant data to the third imaging unit connected thereto, and
the transmission data generators of the first imaging unit and the third imaging unit each clear the last flag in the data received from the upper-stage imaging unit, add own-stage line data after the received data, and add a new last flag to the own-stage line data.

7. The multi-view imaging apparatus of claim 4, wherein
the second imaging unit adds a header to own-stage line data, and transmits the resultant data to the third imaging unit, and
the transmission data generators of the first imaging unit and the third imaging unit each add own-stage line data after the header in the data received from the upper-stage imaging unit.

8. The multi-view imaging apparatus of claim 7, wherein
the transmission data generator of the first or third imaging unit adds own-stage line data corresponding to a line number stored in the header of the received data.

9. The multi-view imaging apparatus of claim 4, wherein
the transmission data generators of the first to third imaging units each add, to own-stage line data, a line number (N) and a final line flag (L) indicating whether or not the own-stage line data is in a final line.

10. The multi-view imaging apparatus of claim 4, wherein
the transmission data generator adds, if line data to be added is missing, dummy data or line data to be transmitted next time instead.

11. The multi-view imaging apparatus of claim 4, wherein
the reception data determiner of the first or third imaging unit comprises a line buffer configured to store the data outputted from the upper-stage imaging unit.

12. The multi-view imaging apparatus of claim 4, wherein
the first or third imaging unit further comprises a transmission possibility/impossibility determiner configured to transmit a control signal indicating that the data is receivable, to the upper-stage imaging unit.

13. The multi-view imaging apparatus of claim 12, wherein
the reception data determiner of the first or third imaging unit comprises a line buffer configured to store the data outputted from the upper-stage imaging unit.

14. The multi-view imaging apparatus of claim 13, wherein
the transmission data generator of the first or third imaging unit adds own-stage data to the data stored in the line buffer, and starts generation of data to be transmitted, upon reception of the control signal.

15. The multi-view imaging apparatus of claim 12, wherein
the transmission possibility/impossibility determiner of the third imaging unit transmits the control signal when the lower-stage and the own-stage imaging units become transmittable.

16. The multi-view imaging apparatus of claim 2, wherein
the image sensors of the first to third imaging units have different resolutions.

17. The multi-view imaging apparatus of claim 16, wherein
the transmission data generators each add information concerning a size of own-stage image data, to own-stage line data.

18. A method of sending a plurality of pieces of image data taken by a plurality of imaging units daisy-chain connected to each other, to an interface unit connected to a lowermost-stage imaging unit, the method comprising:
transmitting, by each of the imaging units other than an uppermost-stage imaging unit, a control signal indicating that data from an upper-stage imaging unit is receivable, to the upper-stage imaging unit; and
adding, by each of the imaging units other than the lowermost-stage imaging unit, own-stage data to the data outputted from the upper-stage imaging unit, and outputting thereby the resultant data to a lower-stage imaging unit, upon reception of the control signal.
